(19) United States
(12) Patent Application Publication
(10) Pub. No.: US 2026/0342261 A1
(43) Pub. Date: Oct. 29, 2026

(54) CIRCUIT FOR CONTROLLING RETRO PULL-CORD FAN AND PULL-CORD FAN

(71) Applicant: SHENZHEN FUNPOWER GENERAL TECHNOLOGY CO., LTD., Shenzhen (CN)

(72) Inventors: Biaowei TAO, Shenzhen (CN); Zhengwei LI, Shenzhen (CN)

(73) Assignee: SHENZHEN FUNPOWER GENERAL TECHNOLOGY CO., LTD., Shenzhen (CN)

(21) Appl. No.: 19/339,623

(22) Filed: Sep. 25, 2025

(30) Foreign Application Priority Data
Apr. 28, 2025 (CN) 202520831178.4

(51) Int. Cl. H02P 25/03; F04D 27/00; G08B 21/18; H05B 45/30

(52) U.S. Cl. CPC H02P 25/03; F04D 27/00; G08B 21/187; H05B 45/30

(57) ABSTRACT

A circuit for controlling a retro pull-cord fan includes a pull-cord switch module, a control module, a motor drive module and an LED drive module. The control module is connected to the pull-cord switch module, and the motor drive module and the LED drive module respectively. The control module is used to receive a first switch signal and a second switch signal inputted by the pull-cord switch module, to output a first control signal to the motor drive module and output a second control signal to the LED drive module. The motor drive module is used to control the fan motor to start or stop, and control the speed of the fan motor through the first control signal.

### CROSS-REFERENCE TO RELATED APPLICATIONS

This application claims priority to Chinese Patent Application No. 202520831178.4, filed on Apr. 28, 2025, the entire disclosure of which is incorporated herein by reference.

### TECHNICAL FIELD

The present application relates to the technical field of electronic circuits, and in particular to a circuit for controlling a retro pull-cord fan and a pull-cord fan.

### BACKGROUND

The household ceiling fan lamp integrates the fan and the illuminating lamp and is hung on the ceiling. In addition to ventilation and illumination, the household ceiling fan lamp also has a decorative effect. The appearance of the ceiling fan lamp will be designed in various styles with different shapes, and one of these ceiling fan lamps designed in a retro style is controlled by a pull-cord switch. Usually there are two pull-cord switches, one to control the fan and the other to control the lamp.

For the fan motor, the alternating current (AC) motor has gradually been replaced by a direct current (DC) brushless motor, and the high-voltage DC brushless motor has evolved into the low-voltage DC brushless motor. For the fan illuminating lamp, the AC lamp has gradually been replaced by the DC LED lamp, and the pull-cord switch is used to turn on or turn off the fan illuminating lamp. The controller of the retro fan lamp controlled by the pull-cord switch mostly adopts a high-voltage DC brushless motor. The high-voltage DC motor not only has high requirements for the production process and the insulation level of the components, but also has low safety and high production cost. Most of the existing fan illuminating lamps are directly connected to the AC input power supply through a pull-cord switch. Due to the functional limitations, the pull-cord switch can only control the lamp on and off, and the function is relatively simple.

### SUMMARY

The main purpose of the present application is to provide a circuit for controlling a retro pull-cord fan and a pull-cord fan, aiming to solve the problem that the retro pull-cord fan has low safety.

To achieve the above purpose, the present application proposes a circuit for controlling the retro pull-cord fan including a pull-cord switch module, a control module, a motor drive module and a light-emitting diode (LED) drive module.

The control module is respectively connected to the pull-cord switch module, the motor drive module and the LED drive module.

The control module is configured to receive a first switch signal inputted by the pull-cord switch module to generate a first control signal corresponding to the first switch signal, and output the first control signal to the motor drive module.

The motor drive module is configured to output a three-phase drive voltage with a voltage value lower than a preset voltage value to a fan motor through the first control signal.

The control module is further configured to receive a second switch signal inputted by the pull-cord switch module to generate a second control signal corresponding to the second switch signal, and output the second control signal to the LED drive module.

The LED drive module is configured to output an LED drive voltage with a voltage value lower than the preset voltage value to a fan lamp through the second control signal.

In an embodiment, the pull-cord switch module includes: a fan pull-cord switch and a lamp pull-cord switch. The control module is connected to the fan pull-cord switch and the lamp pull-cord switch respectively; the fan pull-cord switch is configured to output the first switch signal to the control module; and the lamp pull-cord switch is configured to output the second switch signal to the control module.

In an embodiment, the motor drive module includes a first metal oxide semiconductor (MOS) tube, a second MOS tube, a third MOS tube, a fourth MOS tube, a fifth MOS tube, and a sixth MOS tube. A source of the first MOS tube is connected to an external power supply; a gate of the first MOS tube is connected to a first end of the control module, and a drain of the first MOS tube is connected to a drain of the fourth MOS tube and a first end of the fan motor; a source of the second MOS tube is connected to the external power supply; a gate of the second MOS tube is connected to a second end of the control module, and a drain of the second MOS tube is connected to a drain of the fifth MOS tube and a second end of the fan motor; a source of the third MOS tube is connected to the external power supply; a gate of the third MOS tube is connected to a third end of the control module, and a drain of the third MOS tube is connected to a drain of the sixth MOS tube and a third end of the fan motor; a source of the fourth MOS tube is grounded; a gate of the fourth MOS tube is connected to a fourth end of the control module, and a drain of the fourth MOS tube is further connected to the first end of the fan motor; a source of the fifth MOS tube is grounded; a gate of the fifth MOS tube is connected to a fifth end of the control module, and a drain of the fifth MOS tube is further connected to the second end of the fan motor; and a source of the sixth MOS tube is grounded; a gate of the sixth MOS tube is connected to a sixth end of the control module, and a drain of the sixth MOS tube is further connected to the third end of the fan motor.

In an embodiment, the fan motor is a low-voltage three-phase direct current brushless motor.

In an embodiment, the LED drive module includes a seventh MOS tube and an eighth MOS tube; a source of the seventh MOS tube is grounded; a drain of the seventh MOS tube is connected to a first end of the fan lamp, and a gate of the seventh MOS tube is connected to a seventh end of the control module; and a source of the eighth MOS tube is grounded; a drain of the eighth MOS tube is connected to a second end of the fan lamp, and a gate of the eighth MOS tube is connected to an eighth end of the control module.

In an embodiment, the fan lamp is a low-voltage LED lamp.

In an embodiment, the circuit for controlling the retro pull-cord fan further includes a toggle switch. The toggle switch is connected to an input/output (I/O) pin of the control module; and the toggle switch is configured to send a forward rotation control command and a reverse rotation control command to the control module, to make the control module perform forward rotation control and reverse rotation control of the fan motor.

In an embodiment, the circuit for controlling the retro pull-cord fan further includes an isolation switch power supply. The isolation switch power supply is connected to the control module, the motor drive module and the LED drive module; and the isolation switch power supply is configured to reduce an external output voltage to a preset safety voltage.

In an embodiment, the circuit for controlling the retro pull-cord fan further includes a buzzer. The buzzer is connected to the control module; and the buzzer is configured to perform a fault alarm according to a command action of the control module.

To achieve the above purpose, the present application further proposes a pull-cord fan including the circuit for controlling the retro pull-cord fan as mentioned above.

The present embodiment proposes a circuit for controlling the retro pull-cord fan, which includes a pull-cord switch module, a control module, a motor drive module and an LED drive module. The control module is connected to the pull-cord switch module, and the motor drive module and the LED drive module respectively. The control module is used to receive a first switch signal inputted by the pull-cord switch module to generate a first control signal corresponding to the first switch signal, and output the first control signal to the motor drive module. The motor drive module is used to control the fan motor to start or stop, and control the speed of the fan motor through the first control signal. The control module is further used to receive the second switch signal inputted by the pull-cord switch module to generate the second control signal corresponding to the second switch signal, and output the second control signal to the LED drive module. The LED drive module is used to control the color temperature and brightness of the fan lamp through the second control signal. In the present application, the fan motor is integrated with the fan lamp, and components with a safe voltage that the human body can withstand are adopted, which increases product functions and improves product safety and reliability.

### BRIEF DESCRIPTION OF THE DRAWINGS

FIG. 1 is a module schematic diagram of a circuit for controlling the retro pull-cord fan according to a first embodiment of the present application.

FIG. 2 is a first circuit connection diagram of the circuit for controlling the retro pull-cord fan according to a second embodiment of the present application.

FIG. 3 is a second circuit connection diagram of the circuit for controlling the retro pull-cord fan according to the second embodiment of the present application.

FIG. 4 is a module schematic diagram of the circuit for controlling the retro pull-cord fan according to a third embodiment of the present application.

### DETAILED DESCRIPTION OF THE EMBODIMENTS

It should be understood that embodiments described herein are only used to explain the present application and are not used to limit the present application.

The technical solutions of the embodiments of the present application will be described in detail below with reference to the accompanying drawings. It is obvious that the embodiments described are only some rather than all of the embodiments of the present application. All other embodiments obtained by those skilled in the art based on the embodiments of the present application without creative efforts shall fall within the claimed scope of the present application.

It should be noted that all the directional indications (such as up, down, left, right, front, rear . . . ) in the embodiments of the present application are only used to explain the relative positional relationship, movement, or the like of the components in a certain posture (as shown in the drawings). If the specific posture changes, the directional indication will change accordingly.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

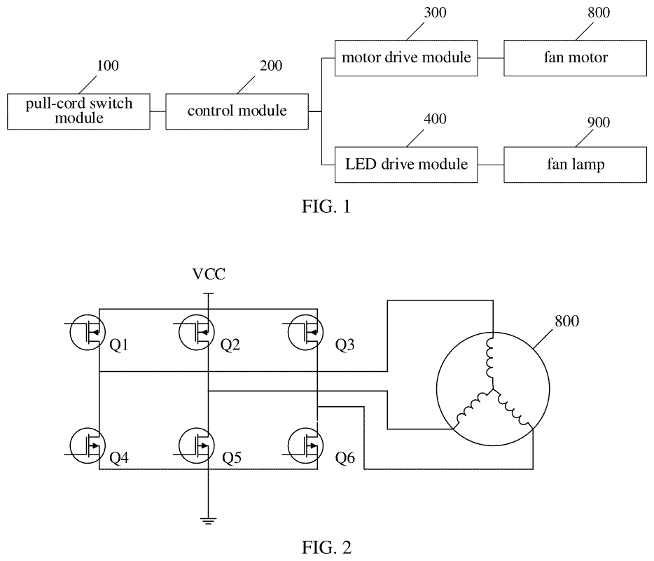

As shown in FIG. 1, FIG. 1 is a module schematic diagram of a circuit for controlling the retro pull-cord fan according to a first embodiment of the present application, and the first embodiment of the circuit for controlling the retro pull-cord fan of the present application is proposed based on FIG. 1.

The circuit for controlling the retro pull-cord fan includes a pull-cord switch module 100, a control module 200, a motor drive module 300 and a light-emitting diode (LED) drive module 400.

The control module 200 is respectively connected to the pull-cord switch module 100, the motor drive module 300 and the LED drive module 400.

It should be understood that the pull-cord switch module 100 is the input part of the entire control circuit. When the user operates the pull-cord switch, a first switch signal and a second switch signal will be generated. The conventional operation mode of the pull-cord switch provides a retro operation experience for fan control.

It should be noted that the control module 200 is a microcontroller unit (MCU). The control module 200 is the core control part of the circuit, which is connected to the pull-cord switch module 100, the motor drive module 300 and the LED drive module 400. The main function of the control module 200 is to receive the first switch signal and the second switch signal transmitted from the pull-cord switch module 100. The switch signal is a discrete signal with only two states, such as the turned-on state and the turned-off state, or the high-level state and the low-level state.

The control module 200 is used to receive the first switch signal inputted by the pull-cord switch module 100 to generate the first control signal corresponding to the first switch signal, and output the first control signal to the motor drive module 300.

It should be understood that, according to the received switch signal, the control module 200 will perform corresponding processing. That is, the control module 200 will generate a first control signal and send it to the motor drive module 300. This first control signal is specifically used to control the fan motor 800.

The motor drive module 300 is used to output a three-phase drive voltage with a voltage value lower than the preset voltage value to the fan motor 800 through the first control signal.

It should be understood that according to the first control signal, the circuit inside the motor drive module 300 adjusts and converts the input voltage to generate a three-phase drive voltage. These voltages are outputted to the fan motor 800 after power amplification and other processing. The motor drive module 300 ensures that the value of the outputted three-phase drive voltage is lower than the preset voltage value through the internal control algorithm and circuit design. The preset voltage value is a safe voltage of DC36V that the human body can withstand.

It should be noted that after receiving the first control signal from the control module 200, the motor drive module 300 can control the fan motor 800. This control includes starting and stopping the fan motor 800, that is, determining whether the fan is operating. In addition, the speed of the fan motor 800 can be further controlled by the motor drive module 300. By adjusting the speed of the motor, different air volume of the fan can be outputted to meet the user's demand for air volume in different environments.

The control module 200 is further used to receive the second switch signal inputted by the pull-cord switch module 100 to generate a second control signal corresponding to the second switch signal, and output the second control signal to the LED drive module 400.

It should be understood that the control module 200 will further generate a second control signal and send it to the LED drive module 400. This second control signal is used to control the fan lamp 900.

The LED drive module 400 is used to output an LED drive voltage whose voltage value is lower than the preset voltage value to the fan lamp 900 through the second control signal.

It should be understood that after receiving the second control signal from the control module 200, the LED drive module 400 will control the fan lamp 900, which includes controlling the color temperature of the fan lamp 900. The adjustment of the color temperature can make the lamp shows different color effects, such as cold white, warm yellow, and the like. The LED drive module 400 can further control the brightness of the fan lamp 900. The user can adjust the light brightness according to actual needs. For example, darker lights may be needed at night, and brighter lights may be needed during the day if the fan lamp 900 is used as auxiliary illumination. The preset voltage value is a safe voltage of DC36V that the human body can withstand.

The present embodiment proposes a circuit for controlling the retro pull-cord fan, which includes a pull-cord switch module 100, a control module 200, a motor drive module 300 and an LED drive module 400. The control module 200 is connected to the pull-cord switch module 100, and the motor drive module 300 and the LED drive module 400 respectively. The control module 200 is used to receive a first switch signal inputted by the pull-cord switch module 100 to generate a first control signal corresponding to the first switch signal, and output the first control signal to the motor drive module 300. The motor drive module 300 is used to control the fan motor 800 to start or stop, and control the speed of the fan motor 800 through the first control signal. The control module 200 is further used to receive the second switch signal inputted by the pull-cord switch module 100 to generate the second control signal corresponding to the second switch signal, and output the second control signal to the LED drive module 400. The LED drive module 400 is used to control the color temperature and brightness of the fan lamp 900 through the second control signal. In the present application, the fan motor 800 is integrated with the fan lamp 900, and components with a safe voltage (less than or equal to DC36V) that the human body can withstand are adopted, which increases product functions and improves product safety and reliability.

As shown in FIG. 2 and FIG. 3, FIG. 2 is a first circuit connection diagram of the circuit for controlling the retro pull-cord fan according to a second embodiment of the present application, and FIG. 3 is a second circuit connection diagram of the circuit for controlling the retro pull-cord fan according to the second embodiment of the present application. Based on the first embodiment of the above-mentioned circuit for controlling the retro pull-cord fan, a second embodiment of the circuit for controlling the retro pull-cord fan of the present application is proposed.

The pull-cord switch module 100 includes a fan pull-cord switch 110 and a lamp pull-cord switch 120.

The control module 200 is further connected to the fan pull-cord switch 110 and the lamp pull-cord switch 120 respectively.

It should be noted that the control module 200 is connected to the fan pull-cord switch 110 and the lamp pull-cord switch 120 respectively. This connection relationship is the basis for realizing the control function. Through this connection, the control module 200 can receive signals from the pull-cord switch and may control or respond to related devices (the fan and the lamp) according to these signals.

The fan pull-cord switch 110 is used to output a first switch signal to the control module 200.

It should be understood that the function of the fan pull-cord switch 110 is to output a first switch signal to the control module 200. The first switch signal is an electrical signal indicating the state of the fan pull-cord switch 110 (for example, the turned-on state and the turned-off state of the fan pull-cord switch 110). When the user operates the fan pull-cord switch 110, the fan pull-cord switch 110 will send the signal representing the switch state to the control module 200, so that the control module 200 can obtain the state of the fan pull-cord switch 110 and perform subsequent processing.

The lamp pull-cord switch 120 is used to output the second switch signal to the control module 200.

It should be noted that the lamp pull-cord switch 120 is used to output the second switch signal to the control module 200. Similarly, the second switch signal is an electrical signal indicating the state of the lamp pull-cord switch 120. When the lamp pull-cord switch 120 is operated, this signal will be transmitted to the control module 200, so that the control module 200 can perform operations, such as controlling the lamp on and off according to the state of the lamp pull-cord switch 120.

The motor drive module 300 includes a first metal oxide semiconductor (MOS) tube Q1, a second MOS tube Q2, a third MOS tube Q3, a fourth MOS tube Q4, a fifth MOS tube Q5, and a sixth MOS tube Q6.

It should be understood that the source of the first MOS tube Q1 is connected to an external power supply, the gate of the first MOS tube Q1 is connected to the first end of the control module 200, and the drain of the first MOS tube Q1 is connected to the drain of the fourth MOS tube Q4 and the first end of the fan motor 800. The source of the second MOS tube Q2 is connected to the external power supply, the gate of the second MOS tube Q2 is connected to the second end of the control module 200, and the drain of the second MOS tube Q2 is connected to the drain of the fifth MOS tube Q5 and the second end of the fan motor 800. The source of the third MOS tube Q3 is connected to the external power supply, the gate of the third MOS tube Q3 is connected to the third end of the control module 200, and the drain of the third MOS tube Q3 is connected to the drain of the sixth MOS tube Q6 and the third end of the fan motor 800. The source of the fourth MOS tube Q4 is grounded, the gate of the fourth MOS tube Q4 is connected to the fourth end of the control module 200, and the drain of the fourth MOS tube Q4 is further connected to the first end of the fan motor 800. The source of the fifth MOS tube Q5 is grounded, the gate of the fifth MOS tube Q5 is connected to the fifth end of the control module 200, and the drain of the fifth MOS tube Q5 is further connected to the second end of the fan motor 800. The source of the sixth MOS tube Q6 is grounded, the gate of the sixth MOS tube Q6 is connected to the sixth end of the control module 200, and the drain of the sixth MOS tube Q6 is further connected to the third end of the fan motor 800.

It should be noted that the first MOS tube Q1, the second MOS tube Q2, and the third MOS tube Q3 are NMOS tubes. The fourth MOS tube Q4, the fifth MOS tube Q5, and the sixth MOS tube Q6 are PMOS tubes.

It should be understood that the fan motor 800 is a low-voltage three-phase direct current brushless motor, which refers to a DC brushless motor with a voltage less than DC36V.

The LED drive module 400 includes a seventh MOS tube Q7 and an eighth MOS tube Q8.

It should be noted that the source of the seventh MOS tube Q7 is grounded, the drain of the seventh MOS tube Q7 is connected to the first end of the fan lamp 900, and the gate of the seventh MOS tube Q7 is connected to the seventh end of the control module 200. The source of the eighth MOS tube Q8 is grounded, the drain of the eighth MOS tube Q8 is connected to the second end of the fan lamp 900, and the gate of the eighth MOS tube Q8 is connected to the eighth end of the control module 200.

It should be understood that the fan lamp 900 is a low-voltage LED lamp, which is a low-voltage component with a safety voltage less than or equal to DC36V.

It should be noted that the fan lamp 900 can be divided into several LED lamp groups with different color temperatures, such as LED A and LED B. By controlling the conduction and cutoff of the seventh MOS tube Q7 and the eighth MOS tube Q8, the LED A and the LED B are controlled to be on or off. By adjusting the duty cycle of the LED pulse-width modulation control signal connected to the MCU. the brightness of the LED lamp is adjusted.

In this embodiment, the circuit for controlling the retro pull-cord fan combines the fan motor 800 and the fan lamp 900 together. The fan motor 800 and the fan lamp 900 use low-voltage components with a safety voltage not greater than DC36V (less than or equal to DC36V), thereby reducing the insulation requirements of the motor to improve safety, reliability and production cost of the product. In addition, since the drive of the LED lamp is controlled by the MCU, a low-voltage LED lamp with multiple color temperatures is equipped, and the input switching value is controlled by the MCU. In this way, brightness and color temperature outputted by the LED lamp can be adjusted through the state change and holding time of the switching value, thereby increasing the product function.

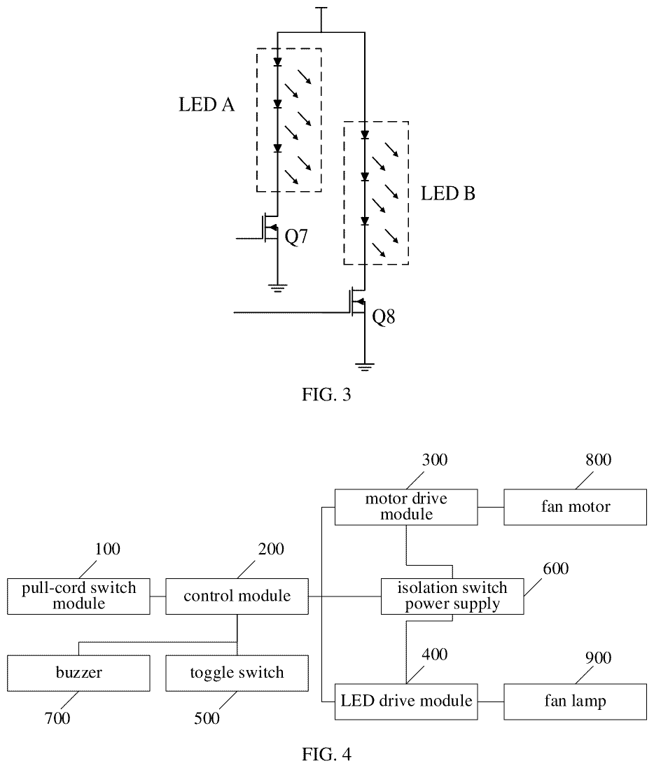

As shown in FIG. 4, FIG. 4 is a module schematic diagram of the circuit for controlling the retro pull-cord fan according to a third embodiment of the present application. Based on the first embodiment and the second embodiment of the circuit for controlling the retro pull-cord fan, the third embodiment of the circuit for controlling the retro pull-cord fan of the present application is proposed.

The circuit for controlling the retro pull-cord fan further includes a toggle switch 500.

The toggle switch 500 is connected to the input/output (I/O) pin of the control module 200.

It should be understood that the toggle switch 500 is connected to the I/O (input/output) pin of the control module 200. This connection enables the toggle switch 500 to interact with the control module 200 for signals. I/O pins are interfaces for the control module 200 to receive external signals (such as control commands of the toggle switch 500) and to send control signals (such as controlling the operation of the fan motor 800).

The toggle switch 500 is used to send forward rotation control commands and reverse rotation control commands to the control module 200, so that the control module 200 can perform forward and reverse rotation control of the fan motor 800.

It should be noted that in the entire circuit for controlling the retro pull-cord fan, the toggle switch 500 plays a key role in sending control commands. The toggle switch 500 is an interactive interface between the user operation and the control module 200. Through this switch, the user can convey the requirements for the operating direction of the fan motor 800 to the control module 200.

It should be understood that when the user operates the toggle switch 500 to a specific position (such as toggling upward or at a set “forward rotation” gear), the toggle switch 500 will send a forward rotation control command to the control module 200. This command is transmitted to the control module 200 through the connected I/O pin in the form of an electrical signal. After receiving the forward rotation control command, the control module 200 will perform a forward rotation control on the fan motor 800 according to the internal program and circuit design. This may involve operations such as power supply and phase sequence control of the motor, so that the fan motor 800 rotates in a clockwise direction (assuming that forward rotation is clockwise).

It should be noted that, similarly, when the user operates the toggle switch 500 to a reverse operation position corresponding to forward rotation (such as toggling downward or at a “reverse rotation” gear), the toggle switch 500 will send a reverse rotation control command to the control module 200. After receiving the reverse rotation control command, the control module 200 will adjust the control strategy for the fan motor 800 to make the fan motor 800 rotate in the counterclockwise direction (opposite to the forward direction). In this way, by simply operating the toggle switch 500, the forward and reverse rotation control on the fan motor 800 can be easily realized to meet different usage requirements, such as changing the direction of air flow.

The circuit for controlling the retro pull-cord fan further includes an isolation switch power supply 600.

The isolation switch power supply 600 is connected to the control module 200, the motor drive module 300 and the LED drive module 400.

It should be noted that the isolation switch power supply 600 is connected to the control module 200. The control module 200 plays a core control role in the circuit for controlling the retro pull-cord fan, and it requires a stable power supply. The isolation switch power supply 600 provides the appropriate voltage to ensure that the control module 200 can work normally, such as accurately receiving the signal of the pull-cord operation, controlling the speed, direction and states of the LED lamp according to the preset logic. The motor drive module 300 is used to drive the fan motor 800 to operate. The isolation switch power supply 600 is connected to the motor drive module 300 to provide energy for the motor drive module 300. Since the motor has requirements for the stability and safety of the power supply during operation, the isolation switch power supply 600 reduces the external voltage to the preset safety voltage and then supplies the reduced voltage to the motor drive module 300, which can avoid damage to the motor caused by excessive voltage, and meet the power requirements for the normal operation of the motor, thereby ensuring that the fan motor 800 stably operates according to the instructions of the control module 200. The LED drive module 400 is a module used to control the LED lamps that may exist on the fan. The isolation switch power supply 600 is connected to the LED drive module 400 to provide power support for the LED drive module 400. Reducing the external voltage to the preset safety voltage and then supplying the reduced voltage to the LED drive module 400 helps protect the LED lamp. Since the LED lamp usually has a specific operating voltage range, the appropriate safety voltage can ensure that the LED lamp emits light normally, and can achieve different illumination effects such as brightness adjustment, flashing mode, etc. according to the settings of the control module 200.

The isolation switch power supply 600 is used to reduce the external output voltage to the preset safety voltage.

It should be understood that the external output voltage mentioned here is the voltage from the external power supply (such as the mains supply, and the like). The voltage of the external power supply is usually high and may have unstable factors, which is not suitable for direct use in the various modules of the fan control circuit. The important function of the isolation switch power supply 600 is to reduce the external output voltage to the preset safety voltage. The preset safety voltage is set according to the working voltage requirements and safety standards of the control module 200, the motor drive module 300 and the LED drive module 400. This safety voltage can not only ensure the normal operation of each module, but also ensure the safety of the entire circuit system, and prevent electrical failures, component damage and even safety accidents that may be caused by excessive voltage, such as avoiding the risk of electric shock to users (lower than DC36V).

The circuit for controlling the retro pull-cord fan further includes a buzzer 700.

The buzzer 700 is connected to the control module 200.

The buzzer 700 is used to perform a fault alarm according to the command action of the control module 200.

It should be noted that when a fault occurs in the fan control circuit, the control module 200 can detect the fault information. For example, it may be an abnormal current in the circuit, a pull-cord sensor failure, or a problem of other components related to the normal operation of the fan. Once the control module 200 detects a fault, it will send a command to the buzzer 700 according to a preset program. After the buzzer 700 receives the command of the control module 200, the buzzer 700 implements information feedback of receiving different command actions, or a fault alarm, through short beeps, multiple short beeps, long beeps of the buzzer 700. This can promptly remind the user that there is a problem with the fan control circuit, so that the user can take corresponding measures, such as maintenance or inspection.

In this embodiment, by connecting the toggle switch 500 to the I/O port of the MCU, the input switching value as the forward and reverse rotation control command can be used to control the fan motor 800 to rotate forward or reverse. The isolation switch power supply 600 is used to reduce the output voltage to a safe voltage of DC36V that the human body can withstand, thereby reducing the insulation requirements of the motor to improve the safety and reliability of the product. The information feedback of receiving different command actions, or the fault alarm, is realized by the short beep, multiple short beep, long beep of the buzzer 700, so that the user can take corresponding measures, such as maintenance or inspection.

In addition, the present application further proposes a pull-cord fan, which includes the circuit for controlling the retro pull-cord fan as described above. Since the pull-cord fan adopts all the technical solutions of all the above embodiments, it has at least all the beneficial effects brought by the technical solutions of the above embodiments, which will not be repeated here.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element.

The above are only some embodiments of the present application, and do not limit the scope of the present application thereto. Under the concept of the present application, any equivalent structural transformation or equivalent process transformation made according to the description and drawings of the present application, or direct/indirect applied in other related technical fields shall fall within the claimed scope of the present application.

1. A circuit for controlling a retro pull-cord fan, comprising: a pull-cord switch module, a control module, a motor drive module and a light-emitting diode (LED) drive module, wherein:
the control module is respectively connected to the pull-cord switch module, the motor drive module and the LED drive module;
the control module is configured to receive a first switch signal inputted by the pull-cord switch module to generate a first control signal corresponding to the first switch signal, and output the first control signal to the motor drive module;
the motor drive module is configured to output a three-phase drive voltage with a voltage value lower than a preset voltage value to a fan motor through the first control signal;
the control module is further configured to receive a second switch signal inputted by the pull-cord switch module to generate a second control signal corresponding to the second switch signal, and output the second control signal to the LED drive module; and
the LED drive module is configured to output an LED drive voltage with a voltage value lower than the preset voltage value to a fan lamp through the second control signal;
the motor drive module comprises a first metal oxide semiconductor (MOS) tube, a second MOS tube, a third MOS tube, a fourth MOS tube, a fifth MOS tube, and a sixth MOS tube;
a source of the first MOS tube is connected to an external power supply; a gate of the first MOS tube is connected to a first end of the control module, and a drain of the first MOS tube is connected to a drain of the fourth MOS tube and a first end of the fan motor;
a source of the second MOS tube is connected to the external power supply; a gate of the second MOS tube is connected to a second end of the control module, and a drain of the second MOS tube is connected to a drain of the fifth MOS tube and a second end of the fan motor;
a source of the third MOS tube is connected to the external power supply; a gate of the third MOS tube is connected to a third end of the control module, and a drain of the third MOS tube is connected to a drain of the sixth MOS tube and a third end of the fan motor;
a source of the fourth MOS tube is grounded; a gate of the fourth MOS tube is connected to a fourth end of the control module, and a drain of the fourth MOS tube is further connected to the first end of the fan motor;
a source of the fifth MOS tube is grounded; a gate of the fifth MOS tube is connected to a fifth end of the control module, and a drain of the fifth MOS tube is further connected to the second end of the fan motor; and
a source of the sixth MOS tube is grounded; a gate of the sixth MOS tube is connected to a sixth end of the control module, and a drain of the sixth MOS tube is further connected to the third end of the fan motor;
wherein:
the LED drive module comprises a seventh MOS tube and an eighth MOS tube;
a source of the seventh MOS tube is grounded; a drain of the seventh MOS tube is connected to a first end of the fan lamp, and a gate of the seventh MOS tube is connected to a seventh end of the control module; and
a source of the eighth MOS tube is grounded; a drain of the eighth MOS tube is connected to a second end of the fan lamp, and a gate of the eighth MOS tube is connected to an eighth end of the control module.

2. The circuit for controlling the retro pull-cord fan of claim 1, wherein:
the pull-cord switch module comprises: a fan pull-cord switch and a lamp pull-cord switch;
the control module is connected to the fan pull-cord switch and the lamp pull-cord switch respectively;
the fan pull-cord switch is configured to output the first switch signal to the control module; and
the lamp pull-cord switch is configured to output the second switch signal to the control module.

3. (canceled)

4. The circuit for controlling the retro pull-cord fan of claim 1, wherein the fan motor is a low-voltage three-phase direct current brushless motor.

5. (canceled)

6. The circuit for controlling the retro pull-cord fan of claim 1, wherein the fan lamp is a low-voltage LED lamp.

7. The circuit for controlling the retro pull-cord fan of claim 1, further comprising a toggle switch, wherein:
the toggle switch is connected to an input/output (I/O) pin of the control module; and
the toggle switch is configured to send a forward rotation control command and a reverse rotation control command to the control module, to make the control module perform forward rotation control and reverse rotation control of the fan motor.

8. The circuit for controlling the retro pull-cord fan of claim 1, further comprising an isolation switch power supply, wherein:
the isolation switch power supply is connected to the control module, the motor drive module and the LED drive module; and
the isolation switch power supply is configured to reduce an external output voltage to a preset safety voltage.

9. The circuit for controlling the retro pull-cord fan of claim 1, further comprising a buzzer, wherein:
the buzzer is connected to the control module; and
the buzzer is configured to perform a fault alarm according to a command action of the control module.

10. A pull-cord fan, comprising the circuit for controlling the retro pull-cord fan of claim 1.
